(19) United States
(12) Patent Application Publication
(10) Pub. No.: US 2016/0007085 A1
(43) Pub. Date: Jan. 7, 2016

(54) METHODS AND SYSTEMS OF PRESENTING CENSORED MEDIA CONTENT

(71) Applicant: Youssef Dandachli, Austin, TX (US)

(72) Inventor: Youssef Dandachli, Austin, TX (US)

(21) Appl. No.: 14/323,072

(22) Filed: Jul. 3, 2014

(51) Int. Cl. H04N 21/454; H04N 21/4545

(52) U.S. Cl. CPC H04N 21/454; H04N 21/4542; H04N 21/45455; H04N 21/45457

(57) ABSTRACT

Embodiments disclosed herein may be configured to receive media content from a first user, present censored media content to a second user, and allow the second user to view the media content without any of the media content being censored after a predetermined amount of time has elapsed.

### BACKGROUND INFORMATION

1. Field of the Disclosure

Examples of the present disclosure are related to systems and methods for presenting censored media content to users. Specifically, embodiments are related to presenting media content with censored portions, wherein the censorship is removed once a timer expires.

2. Background

Conventionally media content, such as images, video, etc., is shared among users over a network. Typically, the media content is obtained by a user via various user actions, such as the user taking a picture, downloading an image, etc.

Subsequently, the media content is transmitted from a first user to a second user. Upon the second user receiving the media content, the second user may view, interact with, download, etc. the media content in its entirety.

Conventional systems also allow the first user to censor portions of the media content by pixilating, blurring, clouding, etc. the media content. Thus, the second user cannot view the censored portion of the media content.

However, situations may arise where the first user desires the second user to initially view the media content with censorship, and only view the censored portion of the media data after a given period of time.

Accordingly, needs exist for more efficient and effective systems and methods for presenting censored media content to users, wherein the censored portions of the media content may be presented after a timer has expired.

### SUMMARY

Embodiments described herein are directed towards systems and methods allowing a first user to censor media content, transmit the censored media content to a second user, allow the second user to view the censored media content, and allow the second user to view the media content without censorship after a period of time has expired.

Portions of the media content may be censored for a plurality of different reasons, such as for advertisements, games, etc., wherein the receiving user must wait a predetermined amount of time to view the media content without the censorship. For example, media content may include an advertisement for a product, wherein the advertisement may include a censored coupon code, bar code, q-code, etc.

Subsequently, the receiving user may view the coupon code, bar code, q-code, or advertisement after the predetermined amount of time has lapsed from when the receiving user initially viewed the media content with portions being censored. By requiring the receiving user to wait the predetermined amount of time to view the media content without the censorship, the desirability of the receiving user to view the media content without censorship may increase. This may increase the number of times the receiving user views the censored media content before viewing the uncensored media content.

Embodiments described herein may include a media content server. The media content server may include a content module, a censorship module, a timer module, and a presentation module.

The content module may be configured to receive media content from a first user. The received media content may be image data, video data, audiovisual data, audio data, and/or any other content that may be presented to a user.

The censorship module may be configured to receive censorship data to censor the received media content. For example, the received censorship data may be configured to pixilate, blur, cloud, or alter portions of the media content, such that the entirety of the media content is not clearly presented to a second user.

The timer module may be configured to initiate a timer responsive to the second user being presented with the censored media content. The timer may be configured to be decremented towards a zero value or be incremented towards a time threshold. Responsive to the timer being equal to zero or being greater than the time threshold, the censored portion of the censored media content may be removed. Upon the censorship being removed, the second user may be presented with the media content without the censorship.

The presentation module may be configured to present the media content and the censored media content to the second user. The presentation module may be configured to initially present the censored media content to the second user, and after the timer has expired present the uncensored media content to the second user.

In embodiments, the presentation module may be configured to be present the media content without any censorship to the second user responsive to a predetermined amount of time elapsing, wherein the predetermined amount of time is determined from a point in time when second user views the censored media content.

In embodiments, the presentation module may be configured to present the uncensored media content to the second user without receiving any further commands from the second user to view the uncensored media content. Therefore, after a predetermined amount of time has lapsed from when the censored media content is viewed by the second user, authentication data, access data, encryption data, etc. is not required to be transmitted to, received by, or communicated with the second user.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts one embodiment of a network topology for presenting media content to a user over a network.

FIG. 2 depicts one embodiment of a media content server.

FIG. 3 depicts one embodiment of a method of presenting media content to a user.

FIG. 4 depicts one embodiment of a screenshot of censorship media content being presented to a user.

FIG. 5 depicts one embodiment of a screenshot of censored media content being presented to a user, wherein the censorship data is removed from the media content after a timer has expired.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments disclosed herein may be configured to receive media content from a first user, present censored media content to a second user, and allow the second user to view the media content without any censorship after a predetermined amount of time has lapsed.

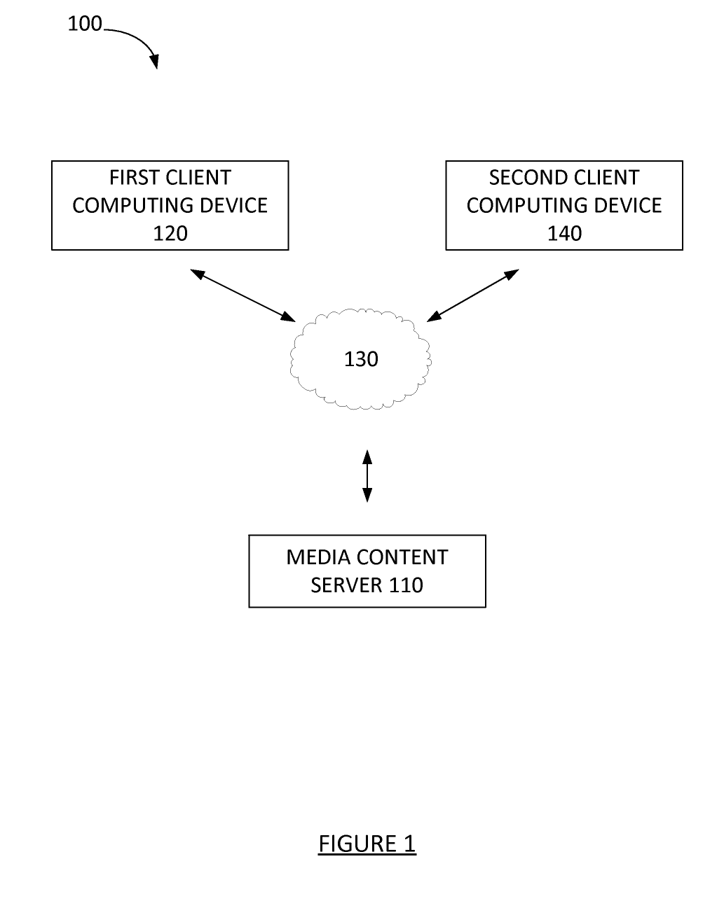

Turning now to FIG. 1, FIG. 1 depicts one topology for presenting media content to user. Topology 100 may include a media content server 110, first client computing device 120, and second client computing device 140. The elements depicted in topology 100 may be communicatively coupled to each other over network 130.

Network 130 may be a wired or wireless network such as the Internet, an intranet, a LAN, a WAN, Bluetooth, infrared, a cellular network, or another type of network configured to communicate data. It will be understood that network 130 may be a combination of multiple different kinds of wired or wireless networks, which may operate according to different protocols.

Media content server 110 may be a computing device, such as a general hardware platform server configured to support mobile applications, end user devices, software, and the like executed on client computing devices 120, 140. Media content server 110 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Media content server 110 may include any combination of one or more computer-usable or computer-readable media. For example, media content server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

In embodiments, media content server 110 may be configured to receive media content with censorship data from first client computing device 120, transmit the media content and censorship data to second client computing device 140, and remove the censorship data from the media content after a predetermined amount of time has lapsed. In embodiments, the predetermined amount of time is determined from a point when the media content with the censorship data is presented on second client computing device 140. By requiring the second user to wait a predetermined amount of time to view the media content without the censorship, the desirability of the second user to view the uncensored media content may increase.

First client computing device 120 may be a laptop computer, desktop computer, smart phone, tablet computer, personal data assistant, or any other type of device with a hardware processor that is configured to process instructions and connect to network 130. First client computing device 120 may be configured to receive media content, receive inputs from a user to delineate a portion of the media content that should be censored, and receive a time threshold associated with how long the censored portion of the media content should be censored.

In embodiments, the media content may be image data, video data, audio data, audiovisual data, etc. Additionally, the first user may dynamically determine the portion of the media content that should be censored, and the time threshold may be a default time period or set by the user of first client computing device 120.

First client computing device 120 may include a graphical user interface (GUI), wherein the GUI may be a device that allows the first user to interact with first client computing device 120. While one GUI is shown, the term “graphical user interface” may include, but is not limited to being, a touch screen, a physical keyboard, a mouse, a camera, a video camera, a microphone, and/or a speaker. Utilizing the GUI the first user may perform actions to determine what portions of the media content should be censored. For example, the first user may perform actions on a touchscreen to create a circle, wherein the portion of the media content within the circle may be censored. Censoring the portion of the media content may include pixilating, blurring, clouding, or altering the portion of the media content, such that the visibility of the censored portion of the media content may be obstructed.

In embodiments, first client computing device 120 may be configured to transmit a data packet to media content server 110, wherein the data packet may include the media content, the censorship data determining the censored portion of the media content, and the time threshold associated with how long the censored portion of the media content should be presented to a second user.

Second client computing device 140 may be a laptop computer, desktop computer, smart phone, tablet computer, personal data assistant, or any other type of device with a hardware processor that is configured to process instructions and connect to network 130.

Second client computing device 140 may include a communication device that is configured to receive the data packet including the media content, censorship data, and time threshold. Second client computing device 140 may also include a presentation device that is configured to present the media content to a user. Responsive to the censored media content being presented to a user of second client computing device 140, a timer may be initiated. Upon the timer being greater than the time threshold, the censored portion of the censored media content may be removed, and the second user may view the media content without the censored portion obscuring the media content. In embodiments, the censored portion of the media content may be removed after a predetermined period of time, and without second client computing device 140 transmitting or receiving further authentications, encryptions, or passwords.

One skilled in the art will appreciate that if multiple client computing devices receive the censored media content, the censored portion of the media content may be removed at different points in time. The censored portion of the media content may be removed from a respective client computing device based on when the user of the respective client computing device initially views the censored media content and the amount of time associated with the time threshold, wherein the time threshold may be the same for each of the plurality of computing devices.

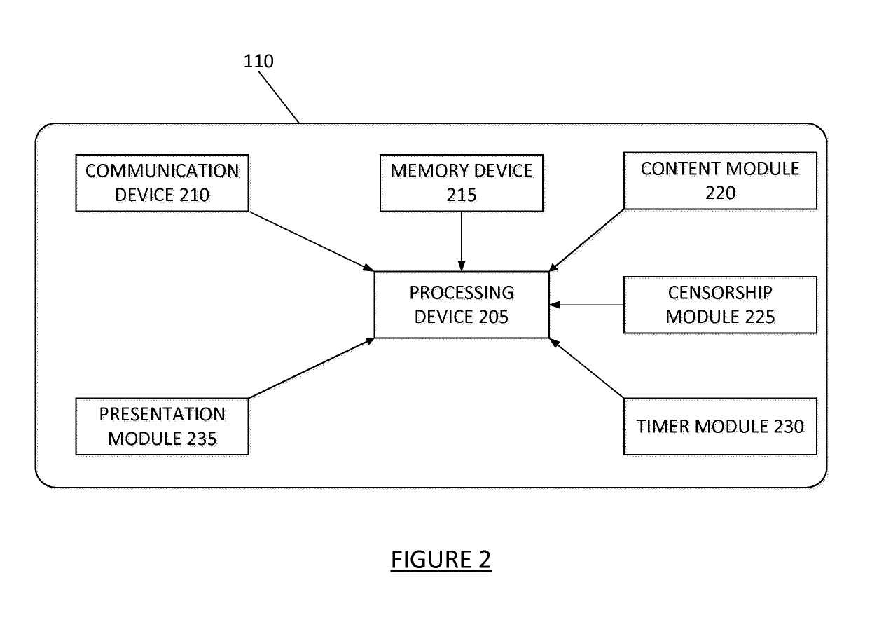

FIG. 2 depicts one embodiment of media content server 110. Media content server 110 may include a processing device 205, communication device 210, memory device 215, content module 220, censorship module 225, timer module 230, and presentation module 235.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of media content server 110 or software associated with other elements of media content server 110.

Communication device 210 may be a device that allows media content server 110 to communicate with another device over network 130. Communication device 210 may include one or more wireless transceivers for performing wireless communication and/or one or more communication ports for performing wired communication over the internet, WLAN, LAN, Bluetooth, PSTN, etc. Communication device 210 may be configured to communicate data over a plurality of different standard and/or protocols.

Memory device 215 may be a device that stores data generated or received by media content server 110. Memory device 215 may include, but is not limited to a hard disc drive, an optical disc drive, and/or a flash memory drive. In embodiments, memory device 215 may be configured to store information received from a first client computing device 120 and/or second computing device 140. The information stored within memory device 215 may be accessed by processing device 205, communication device 210, and/or modules 220, 225, 230, 235. For example, memory device 215 may be configured to store media content in a database, wherein an entry for the media content may include information associated with what portions of the media content should be censored and a time threshold associated with censored media content.

Content module 220 may be a hardware device configured to receive media content from first client computing device 120, wherein the media content may be audio media, video media, audiovisual media, etc. For example, the media content may be a JPEG standard image, a TIFF image, MP3 audio file, digital video, etc. The media content may be configured to be presented to a user of second client computing device 140, such that the user may view, listen to, and/or interact with the media content. In embodiments, the media content may be an advertisement for a product.

Censorship module 225 may be a hardware processing device configured to censor portions of the received media data. Censorship module 225 may be configured to receive censorship data from first client computing device 120, wherein the censorship data indicates which portion(s) of the media content should be censored. The censorship data may be received responsive to a user of first client computing device 120 interacting with the media content to delineate which portions of the media content should be censored. Responsive to receiving the censorship data, censorship module 225 may create censored media content, wherein the delineated portions of the media content are pixilated, blurred, clouded, or altered. For example, the censored portion of the media content may be a coupon code, bar code, q-code, promotion, rebate, discount, etc. associated with a product. The censorship data may be utilized if it is not be desired to initially present the censored portion of the media content to a user of second client computing device 140.

Timer module 230 may be a hardware processing device configured to initiate a timer. The timer may be initiated responsive to a user of second client computing device 140 being presented with the censored media content. Timer module 230 may also be configured to set a time threshold, wherein responsive to the timer incrementing or decrementing past the time threshold, the censored portion of the media content may be removed automatically.

In embodiments, the time threshold may be set by a user of first client computing device 120, and the time threshold may be received along with the media content and censorship data. In further embodiments, the time threshold may be a default value.

Utilizing the timer and the time threshold, the user of the second client computing device 140 may be automatically presented with the uncensored media content after a period of time has lapsed, wherein the uncensored media content is presented to the second user without the second user transmitting or receiving any further authorization to view the uncensored media content.

Accordingly, responsive to the user of second client computing device 140 viewing the censored content for a first time, the timer may be initialized. If the user views the media content before the timer is greater than the time threshold, then the censored portion of the media content may remain censored. If the user views the media content after the timer is greater than or equal to the time threshold, then the user may view the media content without any censorship.

Presentation module 235 may be a hardware processing device configured to present censored media content and media content to users of first client computing device 120 and second client computing device 140.

In embodiments, presentation module 235 may be configured to remove or delete media content transmitted to second client computing device 140 after a second timer is greater than or equal to a second time threshold. The second time threshold may be associated with a time period initialized when the user of second client computing device 120 views the media content with the censorship removed. Therefore, after viewing the uncensored media content, the user of second client computing device 120 may have a predetermined amount of time to utilize a coupon code, promotion, advertisement, etc. associated with the media content. In embodiments, the second time threshold may be a default length of time or a length of time set by the user of first client computing device 120.

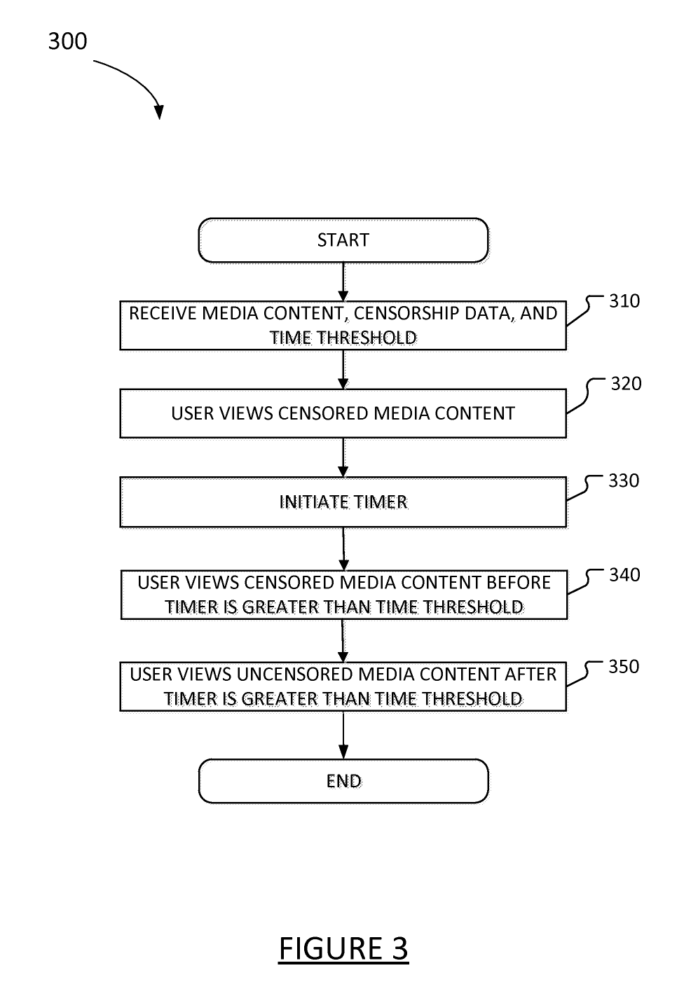

FIG. 3 illustrates a method 300 for presenting censored media content to users. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 310, media content may be received from a first client computing device. The media content may be received with censorship data and a time threshold. The censorship data may delineate which portion(s) of the media content should be censored when presented to a user of a second client computing device. The time threshold may indicate a period of time after the user of the second client computing device views censored media content that the censored portion of the media content may be uncensored. In embodiments, the censorship data and/or the time threshold may be set by a user of the first client computing device. Operation 310 may be performed by a content module that is the same as or similar to content module 220, in accordance with one or more implementations.

At operation 320, the media content, censorship data, and time threshold may be transmitted to the user of the second client computing device. Subsequently, the user of the second client computing device may view the media content with the delineated portion of the media content being censored. Operation 320 may be performed by a censorship module and/or a timer module that are the same as or similar to censorship module 225 and/or a timer module 230, in accordance with one or more implementations.

At operation 330, responsive to the user of the second client computing device viewing the media content with portions being censored, a timer may be initiated. Operation 330 may be performed by a timer module that is the same as or similar to timer module 230, in accordance with one or more implementations.

At operations 340, the user of the second client computing device may desire to view the media content with portions being censored before the timer has incremented to an amount greater than the time threshold. Therefore, the user of the second client computing device may not be able to view the media content with the censored portions being uncensored. Operation 340 may be performed by a presentation module that is the same as or similar to presentation module 235, in accordance with one or more implementations

At operation 350, the user of the second client computing device may desire to view the media content with portions being censored after the timer has incremented to an amount greater than or equal to the time threshold. Responsive to the timer being incremented to an amount greater than or equal to the time threshold, the censored portions of the media content may become uncensored. Therefore, subsequently to the second user initially viewing the censored media content, the user of the second client computing device may be able to view the media content without any censorship after a predetermined period of time. Operation 350 may be performed by a presentation module that is the same as or similar to presentation module 235, in accordance with one or more implementations.

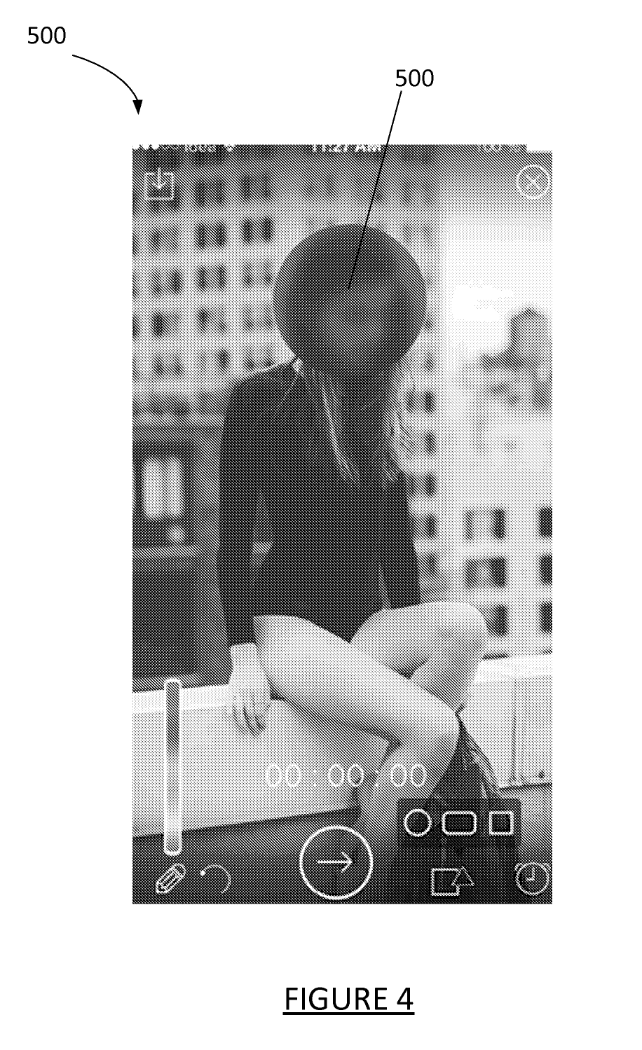

FIG. 4 depicts one embodiment of media content 500, wherein portions of media content 500 may be censored 510. The censored portions 510 of media content 500 may be delineated by a user of first client computing device 120, before the media content 500 is transmitted to content media server 110.

The censored portions 510 of media content 500 may be delineated responsive to the user of first client computing device 120 performing actions to interact with the media content to determine which portions of the media content to censor. Accordingly, any portion of media content 500 may be dynamically censored by the user of first client computing device 510.

In embodiments, the media content 500 with censored portions 510 may be initially presented to a user of second client computing device 140. Responsive to the user of second client computing device 140 viewing media content 500 with censored portions 510, a timer may be initiated.

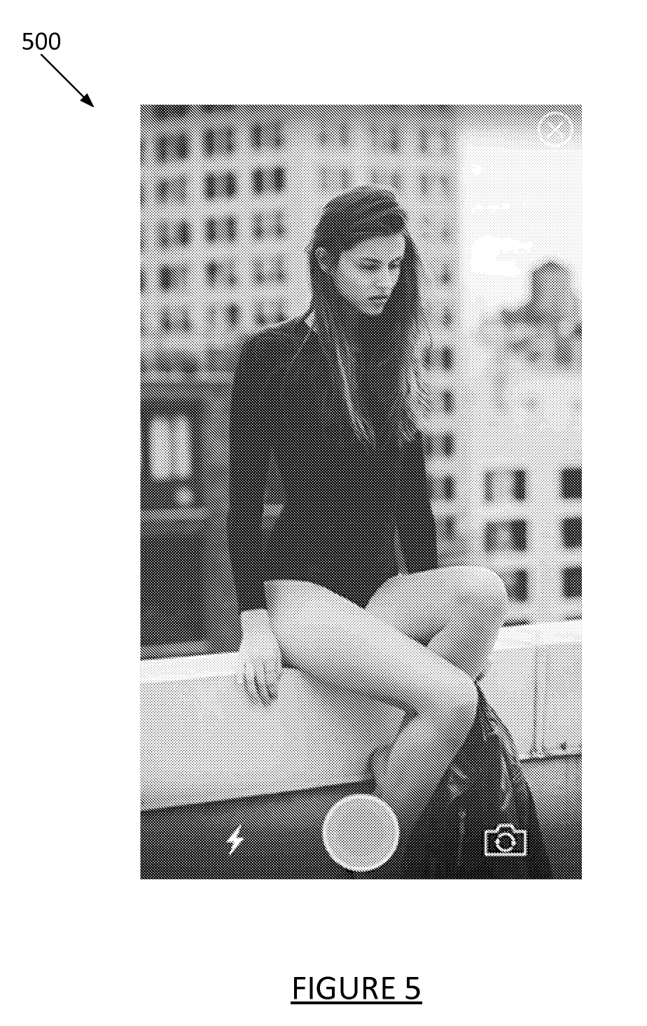

FIG. 5 depicts one embodiment of media content 500 with censored portions 510 being removed. In embodiments, the censored portions of media content 510 may be removed after the timer has incremented to be greater than or equal to the time threshold.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

1. A system for presenting media content over a non-transitory computer-readable medium, the system comprising:
a first client computing device configured to transmit media content, a time threshold, and censorship data;
a graphical user interface associated with the first client computing device configured to input the censorship data via receiving inputs from a user, the censorship data delineating an area of the media content that is censored, the area of the media content that is censored being a first sub-portion of the media content while a second sub-portion of the media content is uncensored;
a communication device configured to receive the media content, the time threshold, and the censorship data;
a censorship module configured to transmit the media content, the time threshold, and the censorship data to a second client computing device;
a timer module configured to initiate a timer responsive to presenting the media content with the censorship data; and
a presentation module associated with the second client computing device configured to simultaneously present the first sub-portion of the media content and the second sub-portion of the media content before the timer is incremented, and the presentation module is configured to present the media content without the censorship data responsive to the timer being incremented to an amount greater than the time threshold.

2. The system of claim 1, wherein the media content, the time threshold, and the censorship data are received from the first client computing device.

3. The system of claim 2, wherein the time threshold is a length of time determined by the user of the first client computing device, and the censorship data is delineated by the user of the first client computing device.

4. The system of claim 1, wherein the media content, the time threshold, and the censorship data are transmitted to the second client computing device.

5. The system of claim 1, wherein when the timer is not incremented to the amount greater than the time threshold the media content is presented with the censorship data.

6. The system of claim 1, wherein the presentation module is configured to determine a second time threshold, wherein the second time threshold is associated with a length of time after the media content is initially presented without the censorship data.

7. The system of claim 6, wherein responsive to the media content being presented without the censorship data a second timer is initiated, and the presentation module is configured to delete the media content responsive to the second timer being incremented to an amount greater than the second time threshold.

8. The system of claim 1, wherein the media content is associated with an advertisement and the censorship data is configured to censor a promotion associated with the advertisement.

9. The system of claim 1, wherein the censorship module configured to transmit the media content, the time threshold, and the censorship data to a plurality of client computing devices, wherein each of the plurality of client computing devices includes a unique timer.

10. The system of claim 9, wherein the unique timer for each of the plurality of client computing devices is initiated responsive to a respective one of the plurality of client computing devices presenting the media content with the censorship data.

11. A method of presenting media content, the method comprising:
transmitting, from a first client computing device, media content, a time threshold, and censorship data, wherein the censorship data is received via inputs from a user, the censorship data delineating an area of the media content that is censored, the area of the media content that is censored being a first sub-portion of the media content while a second sub-portion of the media content is uncensored;
receiving media content, the time threshold, and the censorship data;
transmitting the media content, the time threshold, and the censorship data to a second client computing device;
initiating a timer responsive to presenting the media content with the censorship data;
simultaneously presenting the first sub-portion of the media content and the second sub-portion of the media content on the second client computing device before the timer is incremented;
presenting the media content without the censorship data responsive to the timer being incremented to an amount greater than the time threshold.

12. The method of claim 11, wherein the media content, the time threshold, and the censorship data are received from the first client computing device.

13. The method of claim 12, wherein the time threshold is a length of time determined by the user of the first client computing device, and the censorship data is delimited by the user of the first client computing device.

14. The method of claim 11, wherein the media content, the time threshold, and the censorship data are transmitted to the second client computing device.

15. The method of claim 11, further comprising:
presenting the media content with the censorship data when the timer is not incremented to the amount greater than the time threshold.

16. The method of claim 11, further comprising:
determining a second time threshold, wherein the second time threshold is associated with a length of time after the media content is initially presented without the censorship data.

17. The method of claim 16, further comprising:
initiating a second timer responsive to the media content being presented without the censorship data; and
deleting the media content responsive to the second timer being incremented to an amount greater than the second time threshold.

18. The method of claim 11, wherein the media content is associated with an advertisement and the censorship data is configured to censor a promotion associated with the advertisement.

19. The method of claim 11, further comprising:
transmitting the media content, the time threshold, and the censorship data to a plurality of client computing devices, wherein each of the plurality of client computing devices includes a unique timer.

20. The method of claim 19, further comprising:
initiating the unique timer for a respective one of the plurality of client computing devices responsive to presenting the media content with the censorship data on the respective one of the plurality of client computing devices.
